(19) United States
(12) Patent Application Publication
(10) Pub. No.: US 2018/0080375 A1
(43) Pub. Date: Mar. 22, 2018

(54) Steam Micro Turbine Engine

(71) Applicant: Jack Yajie Chen, Troy, MI (US)

(72) Inventors: Jack Yajie Chen, Troy, MI (US); Maxwell Yiping Chen, Troy, MI (US)

(21) Appl. No.: 15/271,226

(22) Filed: Sep. 21, 2016

(51) Int. Cl. F02C 3/30; H02K 7/18

(52) U.S. Cl. CPC F02C 3/305; F05D 2220/76; H02K 7/1823

(57) ABSTRACT

A steam micro turbine engine is improved from a conventional micro turbine engine by evaporating water into steam in the exhaust heat exchanger, then injecting steam into combustion steam chamber after the fuel is completely burned. A steam micro turbine engine controller monitors the temperatures of the engine, adjusts fuel and water injection amount to maintain the optimal turbine exit temperature. The apparatus can reduce fuel consumption and emission by taking advantage of the waste heat and turning water into steam to generate extra useful work. This steam micro turbine engine could reach 60% efficiency instead of 30% in existing micro turbine engine. This engine can be used in household furnace electric co-generation systems, series hybrid electric vehicles and portable electric generators since its size is small with simplified components, relatively low operating temperature and much lower cost than traditional micro turbine engine.

### BACKGROUND

### 1. Field of the Invention

This disclosure relates to the improved gas micro turbine engine, wherein water is evaporated into steam in the exhaust heat exchanger, then is injected into the combustion chamber to maintain preset exhaust temperature for maximum efficiency with minimum waste heat. The burning air-fuel mixture turns the steam into super-heated steam, thereby reducing intake air while maintaining pressure to drive the turbine for useful work.

### 2. Description of Related Art

Over the past one hundred years, gas turbine engine has been the major power engine for aviation apparatus, ships, locomotives, helicopters, and power plants. Industrial gas turbines usually have fewer moving part than internal combustion reciprocating engines found in most of the motorized vehicles. As the result, gas turbines are more reliable and more efficient. Their efficiency ranges from 35% in simple cycle configuration to 90% in co-generation configuration. However, internal combustion engines (ICE) have been dominated in the small application area, like motorized vehicles, emergency electric generators, lawn mowers etc. because an ICE can be designed and built less expensive and more compact in size although the average ICE thermal efficiency is lower at about 20%.

A typical gas turbine engine consists of a compressor section, a combustion section and a turbine section. Gas turbines are described thermodynamically by the Brayton cycle, in which air is compressed isotropically, combustion occurs at constant pressure, and expansion over the turbine occurs isotropically back to the starting pressure. It uses atmospheric air as the working medium. Flammable fuel burns and heats the atmospheric air to very high temperature (usually in 1000° C.) to achieve differential pressure between turbine inlet and exit. During this process, a huge amount of waste heat is generated and released into the atmosphere. To recover this waste heat in exhaust gas for higher efficiency, manufacturers spend a major portion of the resources into heat exchange systems and multiple stage turbine systems. It increases the size of the generator system and the total cost of the gas turbine.

Although micro turbine engines have a great power-to-weight ratio and are small in size compared to internal combustion reciprocating engines, they have not been used in small applications like motorized vehicles, household emergency electric generators except in large applications like jet airplanes and power plants. The prior arts are not able to address the tough problem in designing and manufacturing gas turbines from both the engineering and materials standpoint because of the high operating temperatures.

High combustion temperature in a gas turbine engine also causes Nitric Oxides emission and reduces turbine blade working life. Some common practices, like injecting steam and cool air into the engine have been applied to slightly reduce the temperature at the turbine blade surface. Strict material requirements to withstand higher temperature and pressure contribute to higher design and fabrication cost.

In most of the prior arts, a compressor is driven by the turbine, which establishes a fixed input and output air ratio. In order to adjust the output power to match the load, the controller can only change the fuel injection amount. It takes significant amount of time (in a few seconds) to have the effect triggered down to the turbine. Thus when the turbine engine is used in automotive applications, it is harder to control the dynamic of the overall output to follow fluctuating load. In this embodiment, the compressor is controlled by an electrical motor, which can be controlled rapidly and precisely by a computer system to adjust output according to the load in addition to the adjustment of the fuel injection amount.

Some prior arts address the waste heat issue by adding an intake-exhaust air recuperator as shown in FIG. 7. It does make some improvement of the thermal efficiency of the engine.

Some prior arts address the NOx emission issue by adding water or steam injection feature to control the combustion temperature as shown in FIG. 6.

### SUMMARY

One aspect of this disclosure is to improve gas micro turbine efficiency and reduce complexity by using steam as the primary working medium instead of atmospheric air. The primary expansion pressure in the combustion chamber is caused by super-heated steam evaporated in the exhaust heat exchanger instead of high temperature exhaust gases. The waste heat is recovered by evaporating the water into pressurized steam mass to generate mechanical work. The exhaust steam mixture temperature at the turbine intake is controlled at much lower level (like 500° C. instead of 1000° C. in most gas turbines) so that the waste heat is minimized.

It is also an object of this disclosure to significantly reduce NOx pollution by controlling fuel combustion temperature well below 1500° C., at which temperature NOx emissions form in significant amount.

It is also an object of this disclosure to significantly reduce unburned fuel, CO by maintaining richer air to fuel ratio so that the fuel is completely burned in the combustion chamber. At least 5% of the oxygen in the air remains after burned with fuel.

In embodiment disclosed in the present disclosure, the temperature at the turbine inlet is reduced from 700-1000° C. to 350-500° C. The loss of thermal volume (about 50%) is replaced by injected steam. The lower operating temperature reduces NOx formation and equal importantly reduces waste heat. The exhaust heat exchanger and condenser convert steam back into water, reduces mass volume and creates low pressure at the exit of the turbine section. Lower operating temperature also reduces the strength requirements for turbine blades and bearing materials, which are big obstacles, in terms of cost, of applying turbine technology in small application such as motorized vehicles and portable electric generators.

In certain embodiments in this disclosure, with the steam vacuum pump, the cold path of the heat exchanger is at lower pressure than 1 atmosphere resulting in lower water boiling point. It ensures the steam in the hot path is condensed back into water as much as possible.

### BRIEF DESCRIPTION OF THE DRAWINGS

FIG. 1 is a diagram of a steam micro turbine engine constructed in accordance with an aspect of the present disclosure.

FIG. 2 is a diagram of a traditional micro turbine engine.

FIG. 3 is a T-S diagram for simple Brayton cycle of a traditional micro turbine engine.

FIG. 4 is a T-S diagram for a steam micro turbine engine constructed in accordance with an aspect of the present disclosure.

FIG. 5 is the flow diagram for a steam micro turbine engine constructed in accordance with an aspect of the present disclosure.

FIG. 6 is the flow diagram for a prior art micro turbine engine with steam injection.

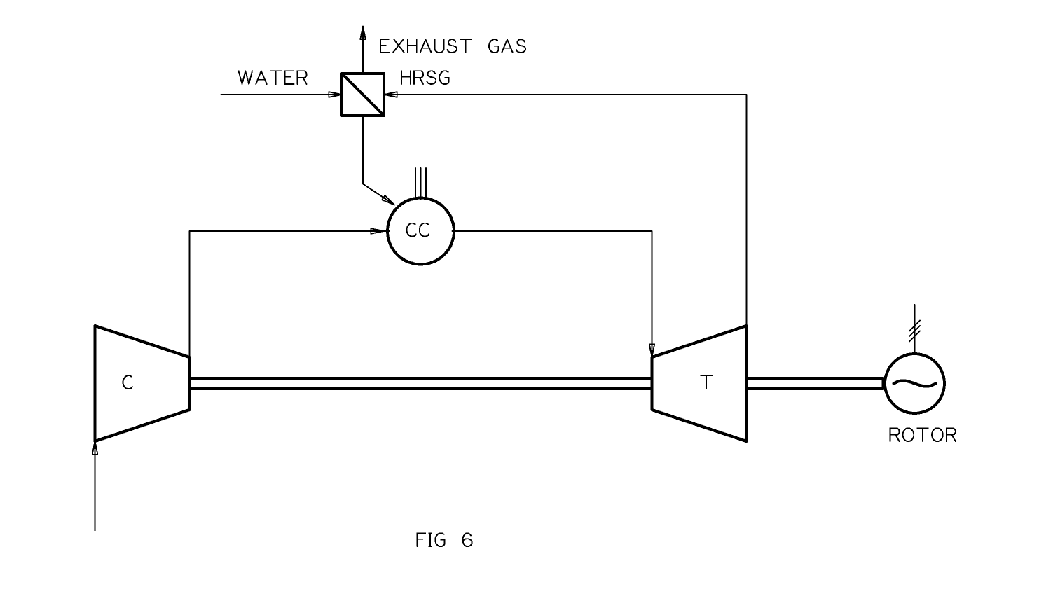

FIG. 7 is the flow diagram for a prior art micro turbine engine with intake air recuperator.

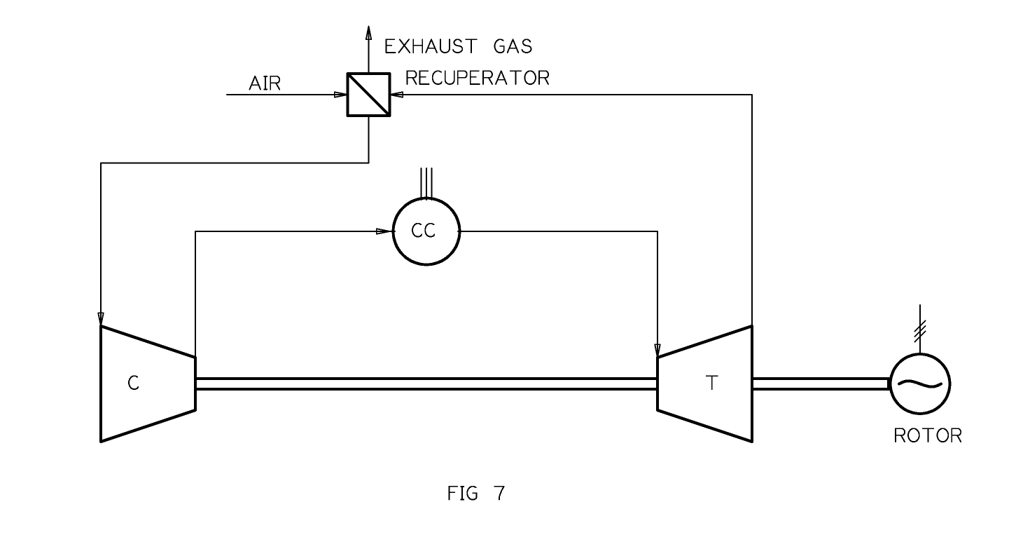

### DESCRIPTION OF ILLUSTRATIVE EMBODIMENTS

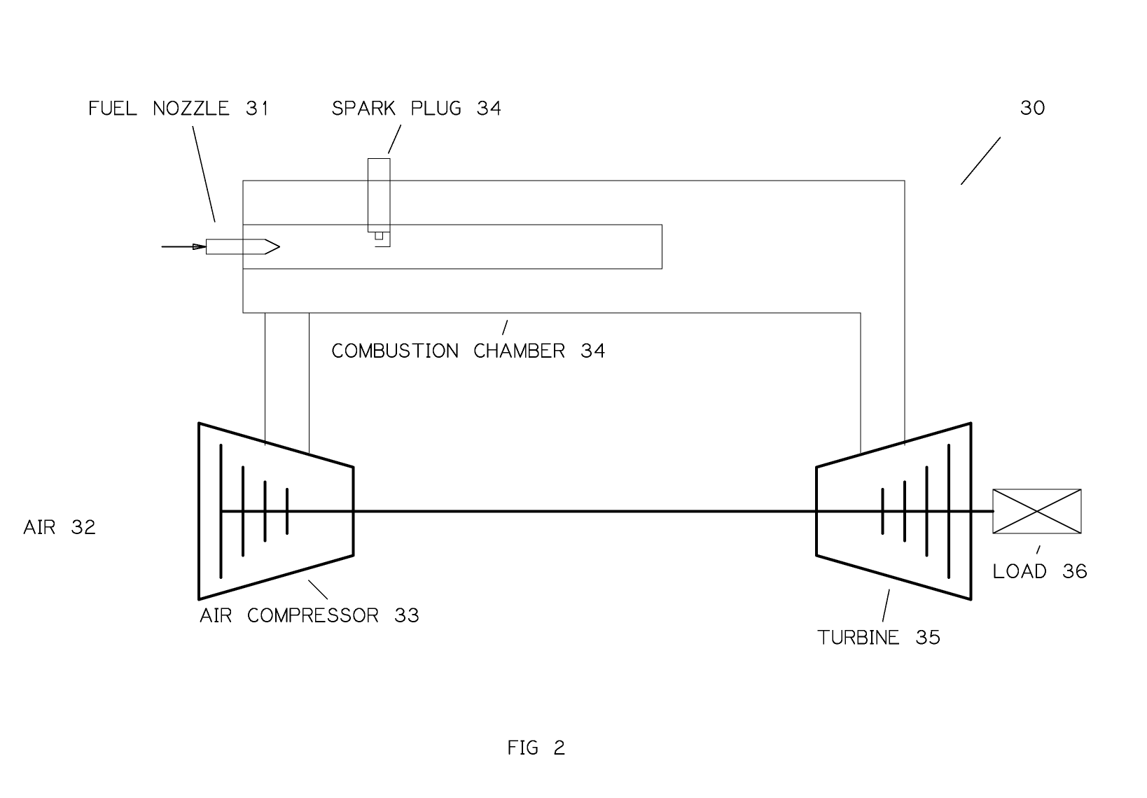

With reference to FIG. 2, a traditional micro turbine engine 30 comprises of air compressor 33, combustion chamber 34, turbine 35, spark plug 34 and fuel nozzle 31. A fresh air steam is compressed by the compressor 33 and enters into combustion chamber 34. It is mixed with the fuel injected by fuel nozzle 31. The spark plug 34 ignites the air-fuel mixture. The mixture is heated by energy released by the chemical reaction in the combustion process and expanding with higher volume and velocity. This exhaust gas flows through turbine to extract energy for useful mechanical work.

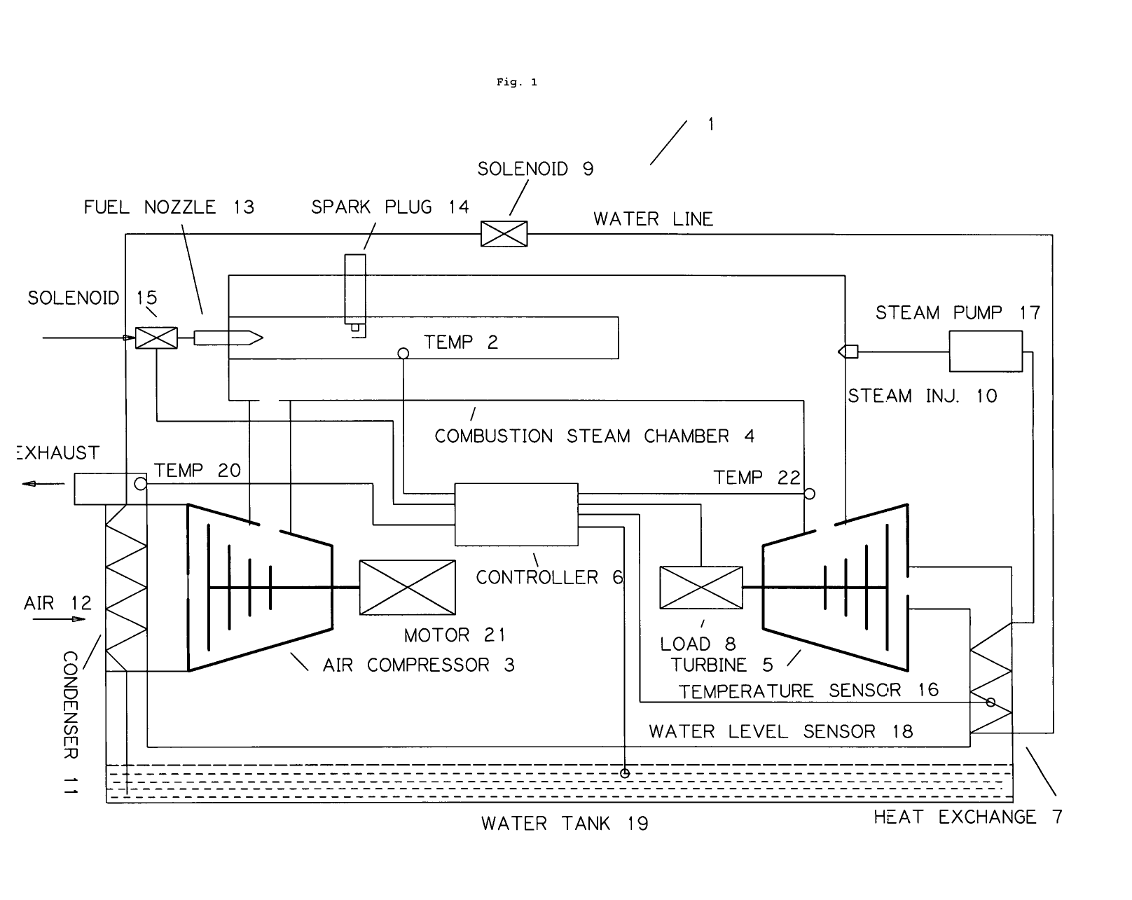

With reference to FIG. 1, a steam micro turbine engine 1 in accordance to an aspect of the present disclosure comprises of air compressor 3, compressor motor 21, combustion steam chamber 4, turbine 5, controller 6, exhaust heat exchange 7, steam vacuum pump 17, spark plug 14, water solenoid 9, fuel nozzle 13, fuel solenoid 15, exhaust condenser 11, water tank 19, water level sensor 18, exhaust heat exchanger temperature sensor 16, exhaust exit temperature sensor 20, combustion chamber temperature sensor 2, turbine entry temperature sensor 22, steam injector 10 and load 8.

A fresh air stream is heated by the exhaust condenser 11 and flows through into the compressor 3. The compressed heated air enters the combustion chamber and is mixed with the fuel that is injected by the fuel nozzle 13. The spark plug 14 ignites the air fuel mixture. The steam injector 10 injects high pressurized steam at the flame front. The exhaust gas quickly heats up the steam into super-heated steam. The steam becomes the primary working fluid with over 50% of the mass volume in the mixture.

The exhaust steam gas mixture enters into the turbine 5. The expansion of this mixture, caused by the differential pressure between the inlet and the ambient pressure, rotates the turbine 5. Useful mechanical work is extracted from this process. It can be used for driving a motorized vehicle or generating electricity through a rotor.

The exhaust steam gas mixture enters the exhaust heat exchanger 7 and is cooled by the water in the cold path of the exhaust heat exchanger 7. The steam in the exhaust mixture is condensed back into water releasing huge amount (>2000 kJ/kg) of heat to evaporate the cold water into steam under low pressure and low boiling point less than 100 degrees Celsius. The condensed water is stored in the water tank 19 for next cycle. The remaining exhaust steam gas goes through the exhaust condenser 11. More thermal energy is transferred to the air flow stream to the compressor in this heat exchange process.

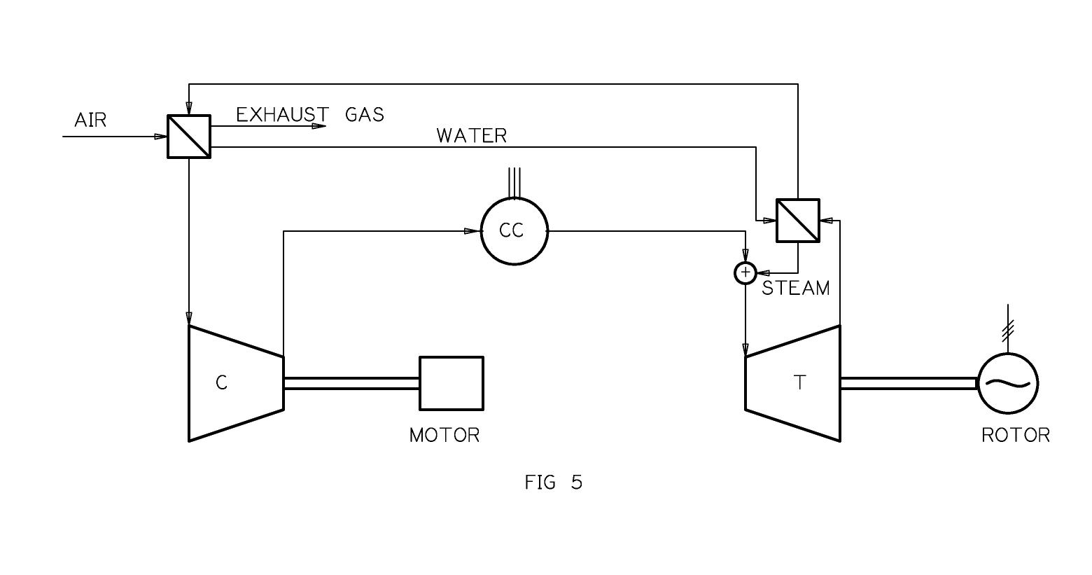

The energy flow diagram is shown in FIG. 5.

The controller 6 adjusts the key input parameters of the engine. The fuel solenoid controls the fuel injection amount based on the power demand of the load. The air compressor proportionally follows the fuel injection amount to maintain rich air to fuel ratio for complete combustion. The water solenoid 9 is turned on and lasts for a duration to provide adequate water amount for injection, which is calculated based on the turbine exit temperature and fuel injection amount. The more fuel is injected into the combustion chamber; the more water is needed. Typically, the higher the turbine exit temperature, the more water is needed, and vice versa. Since the steam micro turbine engine has higher efficiency (about 100% improvement), the fuel injection amount is reduced by 50% comparing to a traditional gas micro turbine.

The water amount can be expressed as the following formula.

water volume=a×f+b×(Te−Tp)

where f is fuel volume, Te is turbine exit temperature, Tp is desired turbine exit temperature, a and b is the coefficient based on engine size and thermal dynamics. The target temperature of Tp is less than 200 degrees Celsius to minimize waste heat.

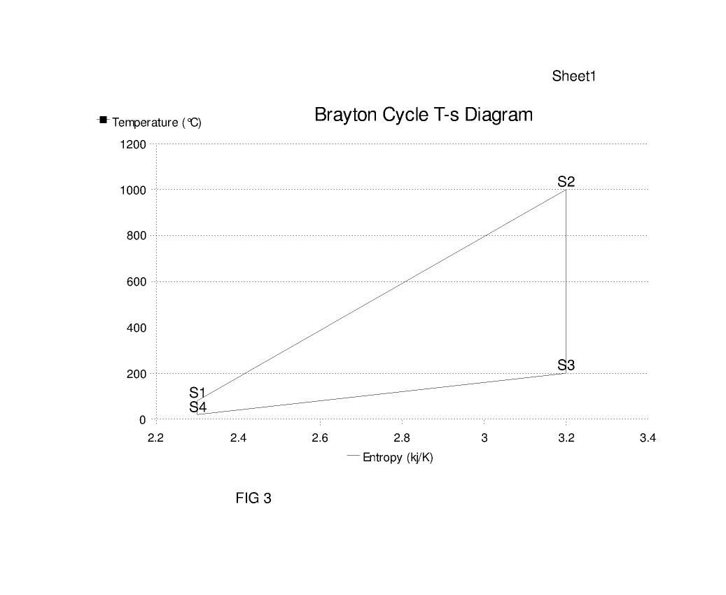

With reference to FIG. 3, it is a basic Brayton cycle diagram; describes the characteristics of a traditional gas turbine engine. Point S4 indicates the air working fluid at the compressor inlet position. Point S1 indicates the air working fluid entry point in the combustion chamber. The transition from point S4 to point S1 represents the adiabatic compression process. Point S2 indicates the air working fluid at the turbine inlet position. The transition from point S1 to point S2 represents the constant pressure heat addition process. Point S3 indicates the air working fluid at the turbine exit position. The transition from point S2 to point S3 represents adiabatic expansion process where the thermal energy is extracted and becomes mechanical work. The transition from point S3 to point S4 represents the constant pressure heat extraction process at which the major deficiency occurs. As the diagram indicates, the temperatures at S2 and S3 are relative high comparing to the outside environment for traditional gas turbine engine. It causes more heat loss during the process.

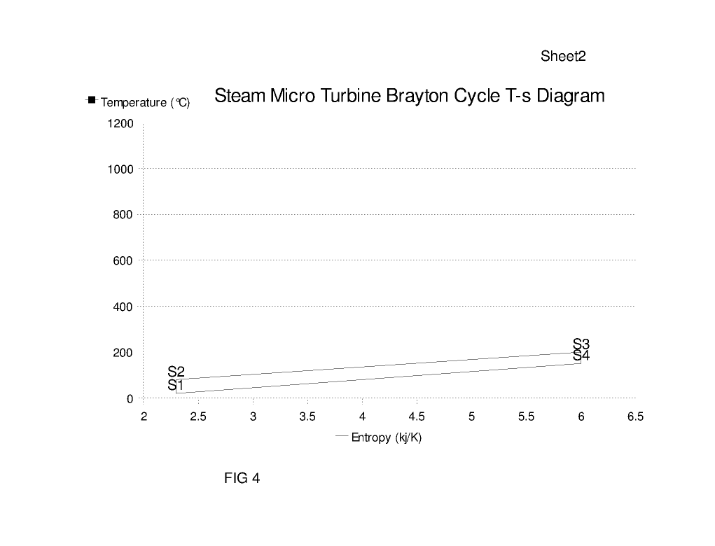

With reference to FIG. 4, it is an improved Brayton Cycle T-S Diagram in accordance with an aspect of the present disclosure. The diagram is similar to FIG. 3 in terms of processes. The significant difference is that the temperatures at point S2 and point S3 are much lower than the ones in traditional gas turbine engine. The other difference is that the entropy property value of steam air mixture working fluid is twice as the one of the air working fluid found in traditional gas turbine engine. The steam air mixture carries more energy per degree temperature. This property makes it a better working fluid than pure air.

The above specification, examples and data provide a complete description of the manufacture and use of the composition of the disclosure. Since many embodiments of the disclosure can be made without departing from the spirit and scope of the disclosure, the disclosure resides in the claims hereinafter appended.

What is claimed is:

1. A steam micro turbine engine, comprising:
compressor motor means, combustion steam chamber means, turbine means, exhaust heat exchanger means, exhaust condenser means, water solenoid means, fuel solenoid means, steam injector means to inject steam into said combustion steam chamber means to generate super-heated steam as primary working fluid with more than 50% in mass of the exhaust gases; compressor means to inject compressed heated air into said combustion steam chamber means; fuel nozzle means for delivering fuel into said combustion steam chamber means; spark plug means to ignite air fuel mixture; steam vacuum pump means to create negative pressure in the said exhaust heat exchanger means and high pressure at the said steam injector means; a control unit to control said compressor motor means speed to maintain a constant rich air to fuel ratio, control said fuel solenoid means of fuel injection amount and control water solenoid means of water injection amount to maintain turbine exit temperature at less than 200 degrees Celsius.

2. A steam micro turbine engine according to claim 1, further comprising a tank to collect and supply water.

3. A steam micro turbine engine according to claim 1, further comprising a water level sensor to detect water tank level.

4. A steam micro turbine engine according to claim 1, further comprising a generator motor to generate electricity.
